(19) United States
(12) Patent Application Publication
(10) Pub. No.: US 2025/0012554 A1
(43) Pub. Date: Jan. 9, 2025

(54) Measuring And Marking Assembly

(71) Applicant: James Taylor, Tucson, AZ (US)

(72) Inventor: James Taylor, Tucson, AZ (US)

(21) Appl. No.: 18/219,054

(22) Filed: Jul. 6, 2023

(51) Int. Cl. G01B 3/1089

(52) U.S. Cl. CPC G01B 3/1089; G01B 2003/1087

(57) ABSTRACT

A measuring and marking assembly includes a tape measure and a clip attached to the housing of the tape measure. A bracket is removably engaged to the tape measure. A clamp is attached to the bracket such that the clamp forms a closed loop and a marker is insertable into the clamp thereby facilitating the marker to mark a line on the work piece. Alight holder is pivotally attached to the bracket and a flashlight is insertable into the light holder thereby facilitating the flashlight to be pivotally retained on the bracket. In this way the flashlight can emit light onto the work piece when the flashlight is turned on. A pencil sharpener is attached to the bracket thereby facilitating the pencil sharpener to sharpen a pencil when the pencil is employed as the marker.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to marking devices and more particularly pertains to a new marking device for precisely marking a line on a work piece. The device includes a tape measure, a bracket that is mounted on the tape measure, a clamp attached to the bracket and a maker that is insertable into the clamp to facilitate the marker to precisely mark a line on the work piece. The device includes a light holder pivotally attached to the bracket and a flashlight that is insertable into the light holder.

### (2) Description of Related Art Including Information Disclosed Under 37 CFR 1.97 and 1.98

The prior art relates to marking devices including a variety of tape measure devices that each has structural features which can accommodate and hold a writing utensil for marking a work piece. In no instance does the prior art discloses a tape measure, a bracket that is mountable to the tape measure, a clamp attached to the bracket, a writing utensil that is insertable into the clamp and light holder pivotally attached to the bracket.

### (h) BRIEF SUMMARY OF THE INVENTION

An embodiment of the disclosure meets the needs presented above by generally comprising a tape measure and a clip attached to the housing of the tape measure. A bracket is removably engaged to the tape measure. A clamp is attached to the bracket such that the clamp forms a closed loop and a marker is insertable into the clamp thereby facilitating the marker to mark a line on the work piece. Alight holder is pivotally attached to the bracket and a flashlight is insertable into the light holder thereby facilitating the flashlight to be pivotally retained on the bracket. In this way the flashlight can emit light onto the work piece when the flashlight is turned on. A pencil sharpener is attached to the bracket thereby facilitating the pencil sharpener to sharpen a pencil when the pencil is employed as the marker.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a back perspective view of a measuring and marking assembly according to an embodiment of the disclosure.

FIG. 2 is a back view of a bracket of an embodiment of the disclosure.

FIG. 3 is a front view of a bracket of an embodiment of the disclosure.

FIG. 4 is a left side view of a bracket of an embodiment of the disclosure.

FIG. 5 is a right side view of a bracket of an embodiment of the disclosure.

FIG. 6 is a top view of a bracket of an embodiment of the disclosure.

FIG. 7 is a bottom view of a bracket of an embodiment of the disclosure.

FIG. 8 is a perspective in-use view of an embodiment of the disclosure.

### (j) DETAILED DESCRIPTION OF THE INVENTION

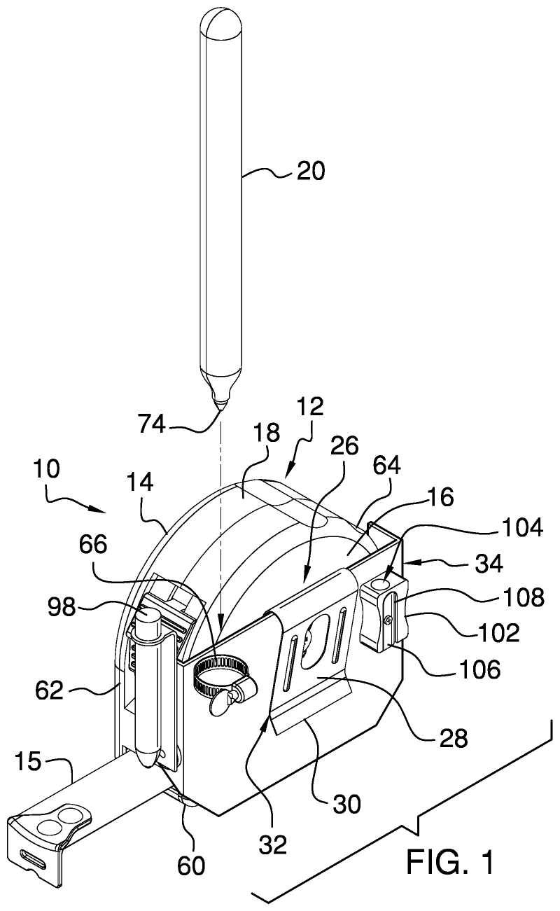

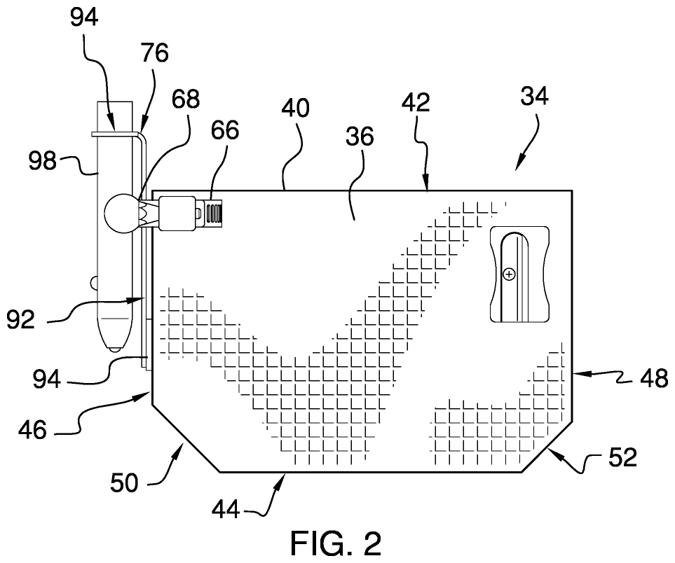

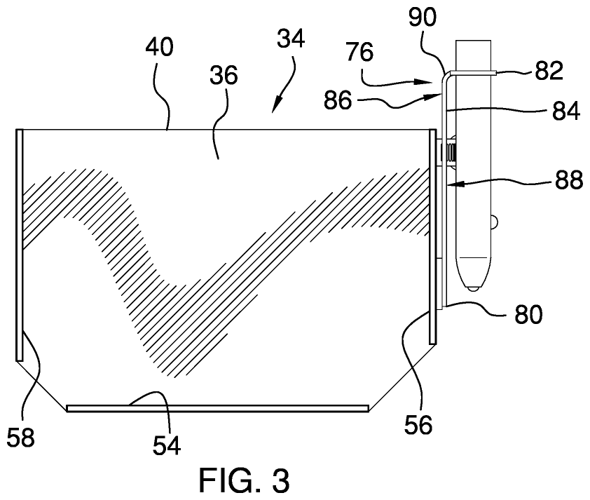

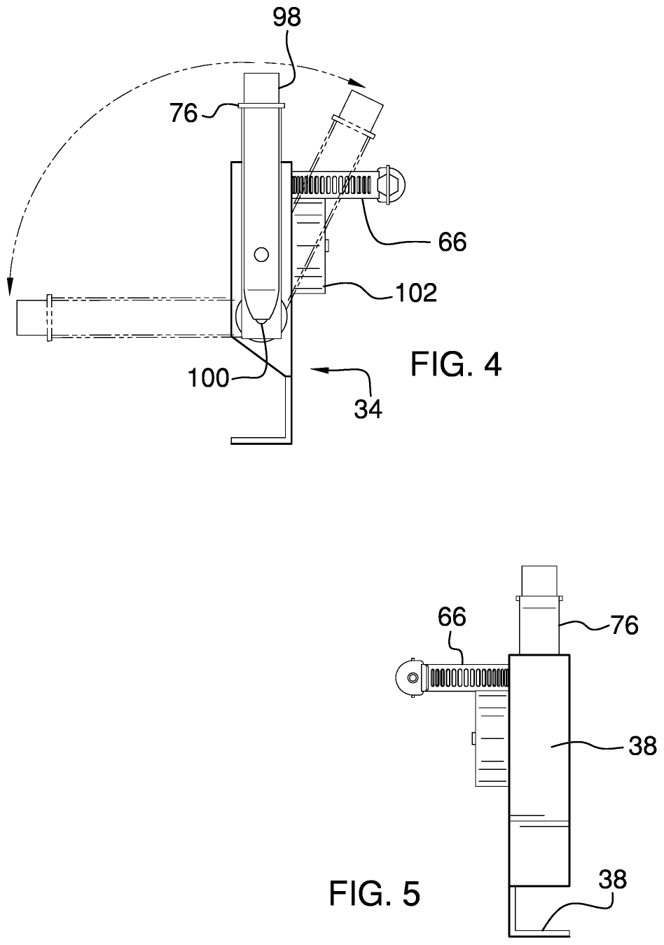

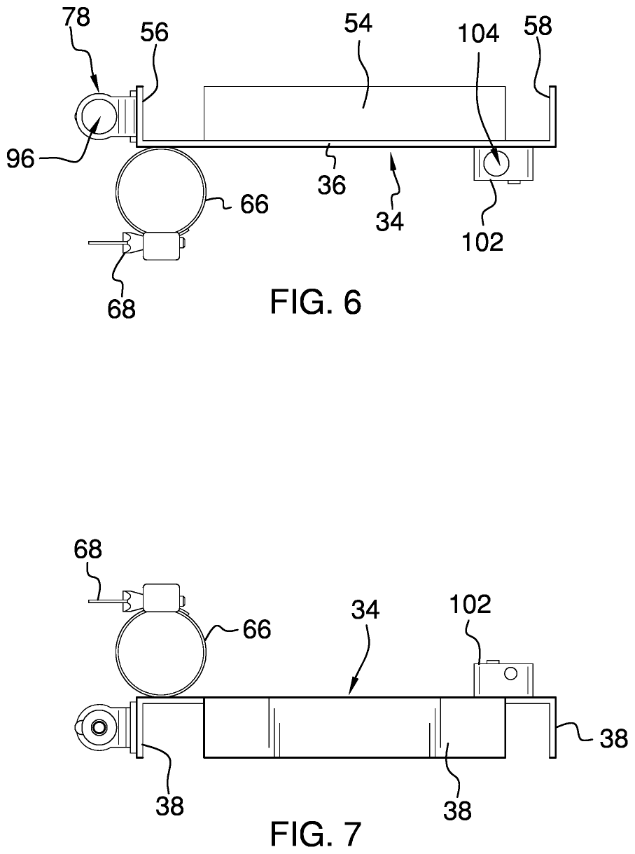

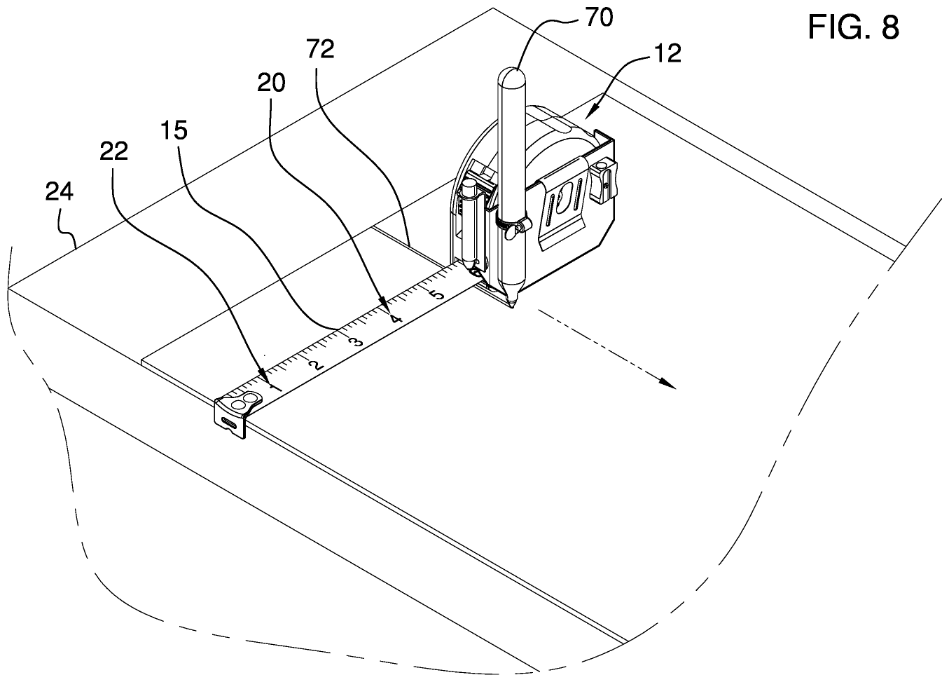

With reference now to the drawings, and in particular to FIGS. 1 through 8 thereof, a new marking device embodying the principles and concepts of an embodiment of the disclosure and generally designated by the reference numeral 10 will be described.

As best illustrated in FIGS. 1 through 8, the measuring and marking assembly 10 generally comprises a tape measure 12 that has a housing 14 and a measuring tape 15 which is drawable outwardly from the housing 14; the housing 14 has a back wall 16 and a perimeter wall 18. The measuring tape 15 has indicia 20 applied thereon comprising a graduated scale 22 thereby facilitating the measuring tape 15 to measure distance on a work piece 24. The tape measure 12 may be a retracting tape measure of any conventional design. A clip 26 is attached to the housing 14 of the tape measure 12 and the clip 26 has a panel 28 that is biased to compress against the back wall 16 of the housing 14. The panel 28 has a bottom end 30 and a bend 32 located adjacent to the bottom end 30 such that the bottom end 30 is directed away from the back wall 16 of the housing 14.

A bracket 34 is provided and the bracket 34 is removably engaged to the tape measure 12. The bracket 34 is slidable between the clip 26 and the housing 14 such that the clip 26 compresses against the bracket 34 to retain the bracket 34 on the tape measure 12. The bracket 34 has a primary wall 36 and a plurality of outer walls 38 each extending forwardly from and being perpendicularly oriented with the primary wall 36. Each of the outer walls 38 is aligned with a perimeter edge 40 of the primary wall 36 and the perimeter edge 40 has a top side 42, a bottom side 44, a first lateral side 46 and a second lateral side 48. The perimeter edge 40 includes a first angled side 50 which angles upwardly between the bottom side 44 and the first lateral side 46 and the perimeter edge 40 includes a second angled side 52 angling upwardly between the bottom side 44 and the second lateral side 48. The bracket 34 is comprised of a rigid material, including but not being limited to, copper, steel, aluminum or other metallic material.

The plurality of outer walls 38 includes a bottom outer wall 54, a first lateral outer wall 56 and a second lateral outer wall 58 and the bottom outer wall 54 is aligned with and extends along a full length of the bottom side 44. The first lateral outer wall 56 is aligned with and extends along a full length of the first lateral side 46; the second lateral outer wall 58 is aligned with and extends along a full length of the second lateral side 48. The bottom outer wall 54 abuts a lower side 60 of the perimeter wall 18 of the housing 14 associated with the tape measure 12. The first lateral outer wall 56 abuts a first sidelong side 62 of the perimeter wall 18 of the housing 14 associated with the tape measure 12. The second lateral outer 58 wall abuts a second sidelong side 64 of the perimeter wall 18 of the housing 14 associated with the tape measure 12. The primary wall 36 is positioned between the panel 28 associated with the clip 26 and the back wall 16 of the housing 14 associated with the tape measure 12 for retaining the bracket 34 on the housing 14.

A clamp 66 is attached to the bracket 34 such that the clamp 66 forms a closed loop and the clamp 66 has a screw 68 that is either tightenable or loosenable. The closed loop defined by the clamp 66 is reduced in diameter when the screw 68 is tightened. Conversely, the closed loop defined by the clamp 66 is increased in diameter when the screw 68 is loosened. The clamp 66 is positioned on the primary wall 36 of the bracket 34 at point located proximate an intersection between the first lateral outer wall 56 of the bracket 34 and the top side 42 of the perimeter edge 40 of the bracket 34. The clamp 66 is oriented such that the closed loop defined by the clamp 66 encircles an axis extending between the top side 42 and the bottom side 44 of the perimeter edge 40 of the bracket 34. Furthermore, the clamp 66 may comprise a hose clamp or other type of adjustable mechanical clamp.

A marker 70 is insertable into the clamp 66 thereby facilitating the marker 70 to be vertically oriented on the tape measure 12. In this way the marker 70 can mark a line 72 on the work piece 24 when the tape measure 12 is employed to measure the work piece 24. The marker 70 is positionable in the clamp 66 such that a marking tip 74 of the marker 70 is aligned with the lower side 60 of the perimeter wall 18 of the housing 14 associated with the tape measure 12. In this way the marking tip 74 can mark the work piece 24. The clamp 66 is tightened around the marker 70 when the screw 68 is tightened for retaining the marker 70 at a selected position on the bracket 34. Conversely, the clamp 66 is loosened around the marker 70 when the screw 68 is loosened to facilitate the marker 70 to be removed from the clamp 66. The marker 70 may be a felt tip marker, a ballpoint pen, a pencil or any other type of cylindrical writing utensil.

A light holder 76 is pivotally attached to the bracket 34 and the light holder 76 has a collar element 78 which forms a closed loop. The light holder 76 has a first end 80, a second end 82 and an outer surface 84 extending between the first end 80 and the second end 82 and the outer surface 84 has a back side 86 and a front side 88. The light holder 76 has a bend 90 which is positioned closer to the second end 82 than the first end 80 to define a first portion 92 of the light holder 76 that is perpendicularly oriented with a second portion 94 of the light holder 76. The first end 80 is associated with the first portion 92, the second end 82 is associated with the second portion 94 and the second end 82 is rounded. The first portion 92 of the light holder 76 is pivotally attached to the first lateral outer wall 56 of the bracket 34 at a pivot point 94 that is positioned proximate the first end 80. The light holder 76 has a hole 96 extending through the front side 88 and the back side 86 of the outer surface 84 such that the hole 96 defines the collar element 78 and the hole 96 is positioned on the second portion 94 of the light holder 76.

A flashlight 98 is insertable through the collar element 78 of the light holder 76 thereby facilitating the flashlight 98 to be pivotally retained on the bracket 34. In this way the flashlight 98 can emit light onto the work piece 24 when the flashlight 98 is turned on. The flashlight 98 is insertable through the hole 96 in the second portion 94 of the light holder 76 such that an emitting end 100 of the flashlight 98 is positioned adjacent to the first end 80 of the light holder 76. A pencil sharpener 102 is attached to the bracket 34 thereby facilitating the pencil sharpener 102 to sharpen a pencil when the pencil is employed as the marker 70. The pencil sharpener 102 has an insertion tunnel 104 for insertably receiving the pencil and a blade 106 which has a cutting edge 108. The cutting edge 108 is aligned with the insertion tunnel 104 thereby facilitating the cutting edge 108 to trim the pencil into a point when the pencil is rotated in the insertion tunnel 104.

In use, the bracket 34 is inserted into the clip 26 to mount the bracket 34 to the tape measure 12. The marker 70 is inserted into the clamp 66 and is adjusted to align the marking tip 74 with the bottom side 44 of the perimeter wall 18 of the tape measure 12. The measuring tape 15 is drawn outwardly from the housing 14 associated with the tape measure 12 to a desired length and the tape measure 12 is slid laterally along the work piece 24. In this way the marker 70 marks a line 72 on the work piece 24 at a precise location along the work piece 24. Furthermore, the tape measure 12 can be slid along the full length of the work piece 24, if so desired, in order to mark a line 72 that runs the full length of the work piece 24. In this way the work piece 24 can be precisely cut along the line 72. Additionally, the flashlight 98 can be inserted into the light holder 76 and the light holder 76 can be pivoted to facilitate the flashlight 98 to emit light in a variety of angles with respect to the tape measure 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A measuring and marking assembly for simultaneously measuring distance of a work piece and marking a line on the work piece, said assembly comprising:
a tape measure having a housing and a measuring tape which is drawable outwardly from said housing, said measuring tape having indicia applied thereon comprising a graduated scale wherein said measuring tape is configured to measure distance on a work piece;
a clip being attached to said housing of said tape measure;
a bracket being removably engaged to said tape measure, said bracket being slidable between said clip and said housing such that said clip compresses against said bracket to retain said bracket on said tape measure;
a clamp being attached to said bracket such that said clamp forms a closed loop, said clamp having a screw being either tightenable or loosenable, said closed loop defined by said clamp being reduced in diameter when said screw is tightened, said closed loop defined by said clamp being increased in diameter when said screw is loosened;
a marker being insertable into said clamp thereby facilitating said marker to be vertically oriented on said tape measure wherein said marker is configured to mark a line on the work piece when said tape measure is employed to measure the work piece;
a light holder being pivotally attached to said bracket, said light holder having a collar element forming a closed loop;
a flashlight being insertable through said collar element of said light holder thereby facilitating said flashlight to be pivotally retained on said bracket wherein said flashlight is configured to emit light onto the work piece when said flashlight is turned on; and
a pencil sharpener being attached to said bracket thereby facilitating said pencil sharpener to sharpen a pencil when said pencil is employed as said marker.

2. The assembly according to claim 1, wherein:
said bracket has a primary wall and a plurality of outer walls each extending forwardly from and being perpendicularly oriented with said primary wall, each of said outer walls being aligned with a perimeter edge of said primary wall, said perimeter edge having a top side, a bottom side, a first lateral side and a second lateral side, said perimeter edge including a first angled side angling upwardly between said bottom side and said first lateral side, said perimeter edge including a second angled side angling upwardly between said bottom side and said second lateral side;
said plurality of outer walls includes a bottom outer wall, a first lateral outer wall and a second lateral outer wall;
said bottom outer wall is aligned with and extends along a full length of said bottom side;
said first lateral outer wall is aligned with and extends along a full length of said first lateral side; and
said second lateral outer wall is aligned with and extends along a full length of said second lateral side.

3. The assembly according to claim 2, wherein:
said housing has a back wall and a perimeter wall;
said clip has a panel being biased to compress against said back wall of said housing, said panel having a bottom end and a bend located adjacent to said bottom end such that said bottom end is directed away from said back wall of said housing;
said bottom outer wall of said bracket abuts a lower side of said perimeter wall of said housing associated with said tape measure;
said first lateral outer wall of said bracket abuts a first sidelong side of said perimeter wall of said housing associated with said tape measure;
said second lateral outer wall of said bracket abuts a second sidelong side of said perimeter wall of said housing associated with said tape measure; and
said primary wall of said bracket is being positioned between said panel associated with said clip and said back wall of said housing associated with said tape measure for retaining said bracket on said housing.

4. The assembly according to claim 2, wherein said clamp is positioned on said primary wall of said bracket at point located proximate an intersection between said first lateral outer wall of said bracket and said top side of said perimeter edge of said bracket, said clamp being oriented such that said closed loop defined by said clamp encircles an axis extending between said top side and said bottom side of said perimeter edge of said bracket.

5. The assembly according to claim 3, wherein said marker is positionable in said clamp such that a marking tip of said marker is aligned with said lower side of said perimeter wall of said housing associated with said tape measure wherein said marking tip is configured to mark the work piece, said clamp being tightened around said marker when said screw is tightened for retaining said marker at a selected position on said bracket, said clamp being loosened around said marker when said screw is loosened to facilitate said marker to be removed from said clamp.

6. The assembly according to claim 2, wherein said light holder has a first end, a second end and an outer surface extending between said first end and said second end, said outer surface having a back side and a front side, said light holder having a bend being positioned closer to said second end than said first end to define a first portion of said light holder being perpendicularly oriented with a second portion of said light holder, said first end being associated with said first portion, said second end being associated with said second portion, said second end being rounded, said first portion of said light holder being pivotally attached to said first lateral outer wall of said bracket at a pivot point being positioned proximate said first end.

7. The assembly according to claim 6, wherein said light holder has a hole extending through said front side and said back side of said outer surface such that said hole defines said collar element, said hole being positioned on said second portion of said light holder.

8. The assembly according to claim 7, wherein said flashlight is insertable through said hole in said second portion of said light holder such that an emitting end of said flashlight is positioned adjacent to said first end of said light holder.

9. A measuring and marking assembly for simultaneously measuring distance of a work piece and marking a line on the work piece, said assembly comprising:
a tape measure having a housing and a measuring tape which is drawable outwardly from said housing, said measuring tape having indicia applied thereon comprising a graduated scale wherein said measuring tape is configured to measure distance on a work piece, said housing having a back wall and a perimeter wall;
a clip being attached to said housing of said tape measure, said clip having a panel being biased to compress against said back wall of said housing, said panel having a bottom end and a bend located adjacent to said bottom end such that said bottom end is directed away from said back wall of said housing;
a bracket being removably engaged to said tape measure, said bracket being slidable between said clip and said housing such that said clip compresses against said bracket to retain said bracket on said tape measure, said bracket having a primary wall and a plurality of outer walls each extending forwardly from and being perpendicularly oriented with said primary wall, each of said outer walls being aligned with a perimeter edge of said primary wall, said perimeter edge having a top side, a bottom side, a first lateral side and a second lateral side, said perimeter edge including a first angled side angling upwardly between said bottom side and said first lateral side, said perimeter edge including a second angled side angling upwardly between said bottom side and said second lateral side, said plurality of outer walls including a bottom outer wall, a first lateral outer wall and a second lateral outer wall, said bottom outer wall being aligned with and extending along a full length of said bottom side, said first lateral outer wall being aligned with and extending along a full length of said first lateral side, said second lateral outer wall being aligned with and extending along a full length of said second lateral side, said bottom outer wall abutting a lower side of said perimeter wall of said housing associated with said tape measure, said first lateral outer wall abutting a first sidelong side of said perimeter wall of said housing associated with said tape measure, said second lateral outer wall abutting a second sidelong side of said perimeter wall of said housing associated with said tape measure, said primary wall being positioned between said panel associated with said clip and said back wall of said housing associated with said tape measure for retaining said bracket on said housing;
a clamp being attached to said bracket such that said clamp forms a closed loop, said clamp having a screw being either tightenable or loosenable, said closed loop defined by said clamp being reduced in diameter when said screw is tightened, said closed loop defined by said clamp being increased in diameter when said screw is loosened, said clamp being positioned on said primary wall of said bracket at point located proximate an intersection between said first lateral outer wall of said bracket and said top side of said perimeter edge of said bracket, said clamp being oriented such that said closed loop defined by said clamp encircles an axis extending between said top side and said bottom side of said perimeter edge of said bracket;
a marker being insertable into said clamp thereby facilitating said marker to be vertically oriented on said tape measure wherein said marker is configured to mark a line on the work piece when said tape measure is employed to measure the work piece, said marker being positionable in said clamp such that a marking tip of said marker is aligned with said lower side of said perimeter wall of said housing associated with said tape measure wherein said marking tip is configured to mark the work piece, said clamp being tightened around said marker when said screw is tightened for retaining said marker at a selected position on said bracket, said clamp being loosened around said marker when said screw is loosened to facilitate said marker to be removed from said clamp;
a light holder being pivotally attached to said bracket, said light holder having a collar element forming a closed loop, said light holder having a first end, a second end and an outer surface extending between said first end and said second end, said outer surface having a back side and a front side, said light holder having a bend being positioned closer to said second end than said first end to define a first portion of said light holder being perpendicularly oriented with a second portion of said light holder, said first end being associated with said first portion, said second end being associated with said second portion, said second end being rounded, said first portion of said light holder being pivotally attached to said first lateral outer wall of said bracket at a pivot point being positioned proximate said first end, said light holder having a hole extending through said front side and said back side of said outer surface such that said hole defines said collar element, said hole being positioned on said second portion of said light holder;
a flashlight being insertable through said collar element of said light holder thereby facilitating said flashlight to be pivotally retained on said bracket wherein said flashlight is configured to emit light onto the work piece when said flashlight is turned on, said flashlight being insertable through said hole in said second portion of said light holder such that an emitting end of said flashlight is positioned adjacent to said first end of said light holder; and
a pencil sharpener being attached to said bracket thereby facilitating said pencil sharpener to sharpen a pencil when said pencil is employed as said marker, said pencil sharpener having an insertion tunnel for insertably receiving said pencil and a blade having a cutting edge being aligned with said insertion tunnel thereby facilitating said cutting edge to trim said pencil into a point when said pencil is rotated in said insertion tunnel.
